(19) United States
(12) Patent Application Publication
(10) Pub. No.: US 2010/0207891 A1
(43) Pub. Date: Aug. 19, 2010

(54) STRUCTURAL IMPROVEMENT TO TOUCH PANEL

(75) Inventor: Kuei Min Wang, Taoyuan County (TW)

Correspondence Address: RABIN & Berdo, PC, 1101 14TH STREET, NW, SUITE 500, WASHINGTON, DC, 20005, US

(73) Assignee: ETURBOTOUCH TECHNOLOGY, INC., Taoyuan County (TW)

(21) Appl. No.: 12/388,612

(22) Filed: Feb. 19, 2009

(51) Int. Cl. G06F 3/041

(52) U.S. Cl. 345/173

(57) ABSTRACT

A structural improvement to a touch panel is provided. comprising a substrate, and a first induction layer and a second induction layer are disposed on different surfaces of the substrate. said induction layers have a plurality of induction lines respectively. Each of the induction lines have a plurality of first induction blocks and second induction blocks having a same area respectively. said induction blocks are connected by first connection sections and second connection sections respectively. The first induction lines and the second induction lines are arranged alternately. said connection sections have a same area, and are in an overlapped area. Thereby, a blank area of the induction layers are reduced, and an induction area inside the touch panel is increased, so as to lower an optical contrast. Moreover, the connection sections have a capacity effect generating a same capacitance value, which prevents error determination or inaccuracy in touch control.

### BACKGROUND OF THE INVENTION

1. Field of Invention

The present invention relates to a touch panel, and more particularly to a structural improvement to a touch panel that increases an induction area inside the touch panel and reduces a blank area to lower an optical contrast.

2. Related Art

With the development of touch panel techniques, and improvement of product performance and component quality, various types of touch panels have been widely applied to various electronic products.

FIG. 1 is a three-dimensional exploded view of a conventional touch panel. As shown in FIG. 1, a touch panel 1 has a substrate 10, an X-axis induction layer 11 and a Y-axis induction layer 12 are disposed on a top surface and a lower surface of the substrate 10 respectively. A plurality of X-axis induction lines 111 is arranged on the X-axis induction layer 11, and a plurality of Y-axis induction lines 121 is arranged on the Y-axis induction layer 12. The X-axis induction lines 111 and the Y-axis induction lines 121 are connected to a control circuit (not shown) respectively. Further, a protective layer 13 is covered on the X-axis induction layer for protecting the X-axis induction layer from damage by an external force. However, the protective layer 13 is very thin, so it will not influence the operation of the touch panel 1.

In operation of the touch panel 1, when a finger or conductor contacts the protective layer 13, a capacity effect is generated at the moment of the contact. According to the change of the capacitance values, the position where the finger or conductor contacts touch panel 1 may be located, i.e., the X-axis induction lines 111 sense the finger or conductor at X-axis position of the touch panel 1, while the Y-axis induction lines 121 sense the finger or conductor at Y-axis position of the touch panel 1. Thus, the position of the finger or conductor on the touch panel 1 is sensed by combining the X-axis induction layer 11 with the Y-axis induction layer 12. Since the input to a capacitive touch panel may be performed by a finger, the input operation is quite convenient, and the contact pressure is not needed in the input operation. Thus, the damage of the touch panel 1 caused by repeated stress deformation may be prevented.

However, the X-axis induction lines 111 and the Y-axis induction lines 121 are mainly in the mesh orthogonal arrangement. In addition to an overlapped area, a blank area is easily generated at other parts, while the overlap area and blank area may easily cause deficiencies, such as error determination of the touch position, decrease of accuracy, and severe optical contrast in the blank area. Therefore, improvement to the structure of the touch panel 1 has been proposed.

For example, ROC Patent Publication No. M338404 has disclosed a capacitive touch panel, in which a protective layer, a plurality of rows of conductive patterns, an insulation layer, and a plurality of columns of conductive patterns are stacked thereon sequentially. Each of the plurality of rows of conductive patterns includes a plurality of first conductive patterns, the lengths of diagonals of which are unequal, and the first conductive patterns are laterally electrically connected, and are electrically connected to a lateral electrode. The plurality of columns of conductive patterns is the same as the plurality of rows of conductive patterns, that is, each of the plurality of columns of conductive patterns includes a plurality of second conductive patterns, the lengths of diagonals of which are unequal, and the second conductive patterns are longitudinally electrically connected, and are electrically connected to a longitudinal electrode.

However, although the capacitive touch panel increases the flexibility of circuit layout, no space exists between the first conductive patterns and the second conductive patterns after overlapping the plurality of rows of conductive patterns and the plurality of columns of conductive patterns. Therefore, when a finger or conductor contacts the protective layer, and the contact point is at the adjacency of the first conductive patterns and the second conductive patterns, an external control circuit may not determine the touch position correctly, which causes error determination or decrease of accuracy.

Again, ROC Patent Publication No. M342558 has disclosed a capacitive touchpad, in which a substrate, an induction layer, and a surface layer are stacked to form a transparent plate body. The induction layer contains a plurality of X-axis traces and Y-axis traces setting in a crossed matrix form. The front end of each X-axis trace and Y-axis trace has a contact, and is electrically connected to a sliver guide disposed at the edge of the panel and conductively connected to a signal output cable, such that the capacitive touchpad transmits an induced signal to a subsequent signal processing circuit through the signal output cable. Here, the plurality of X-axis traces and Y-axis traces are disposed on the same plane, such that the induction units on an individual X-axis trace are connected to one another, and the induction units on an individual Y-axis trace are separated from one another. Further, a bridge structure is disposed between any two adjacent induction units on an Y-axis trace, such that any two adjacent induction units on the Y-axis trace are connected to each other, and are insulated from a part of the Y-axis trace between the two adjacent induction units. The layout position of each induction trace is assured by disposing the X-axis and Y-axis induction traces on the same plane so as to improve the induction performance of the touchpad in terms of sensitivity and accuracy.

However, although the capacitive touch panel improves the sensitivity and accuracy, as the plurality of X-axis traces and Y-axis traces are separated by the bridge structures and are disposed on the same plane, the process for manufacturing the touch panel becomes more complicated, and the yield is reduced. Meanwhile, the bridge structures may be easily deformed or damaged because of the great force in touching the touch panel, which may further influence the accuracy of the touch panel.

### SUMMARY OF THE INVENTION

In consideration of above requirements, the inventor designs a novel structural improvement to a touch panel through careful research and years of experience in this field.

The present invention is directed to a structural improvement to a touch panel, which increases an induction area inside the touch panel.

The present invention is also directed to a structural improvement to a touch panel, which improves accuracy of touch control of the touch panel.

The present invention is further directed to a structural improvement to a touch panel, which reduces an optical contrast of a blank area to an induction block of the touch panel.

To achieve the above objectives, the structural improvement to a touch panel of the present invention has a touch panel. The touch panel includes a substrate, a first induction layer disposed on a first surface of the substrate, a second induction layer disposed on a second surface of the substrate, and a protective layer disposed on a surface of the first induction layer.

The first induction layer has a plurality of first induction lines, which have a plurality of first induction blocks respectively. The induction blocks are connected by first connection sections.

Similar to the first induction layer, the second induction layer has a plurality of second induction lines, and each of the second induction lines has a plurality of second induction blocks connected by second connection sections.

The first induction layer is disposed on the first surface of the substrate, and the second induction layer is disposed on the second surface of the substrate. The first induction lines and the second induction lines are arranged alternately, that is, the first induction blocks of the first induction lines and the second induction blocks of the second induction lines are arranged in a matrix or an array. The first connection sections and the second connection sections are in an overlapped area. Meanwhile, the first connection sections and the second connection sections have a same area, and are in one of a round shape, a W shape, a V shape, a U shape, an M shape, an N shape, a Z shape, a corrugated shape, a consecutive curved shape, or a non-linear consecutive zigzag shape. Also, the first induction blocks and the second induction blocks have a same area, and are in one of a round shape, a parallelogram shape, a rhombus shape, a square shape, or a polygon shape.

Thus, the first induction blocks are distributed on the first surface of the substrate, while the second induction blocks are distributed on the second surface of the substrate. The first connection sections and the second connection sections are in an overlapped area, and are distributed on the whole substrate uniformly to reduce the blank area between the first induction layer and the second induction layer. Because the blank area is reduced, the optical contrast is reduced while the touch area of the substrate is increased. Moreover, if the touch point is on the first connection sections and the second connection sections, the same capacity effect may be generated because the first connection sections and the second connection sections have the same area. Thus, when analyzing and determining the touch point, an external control circuit of the touch panel will not have error determination or inaccuracy.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional exploded view of a conventional touch panel;

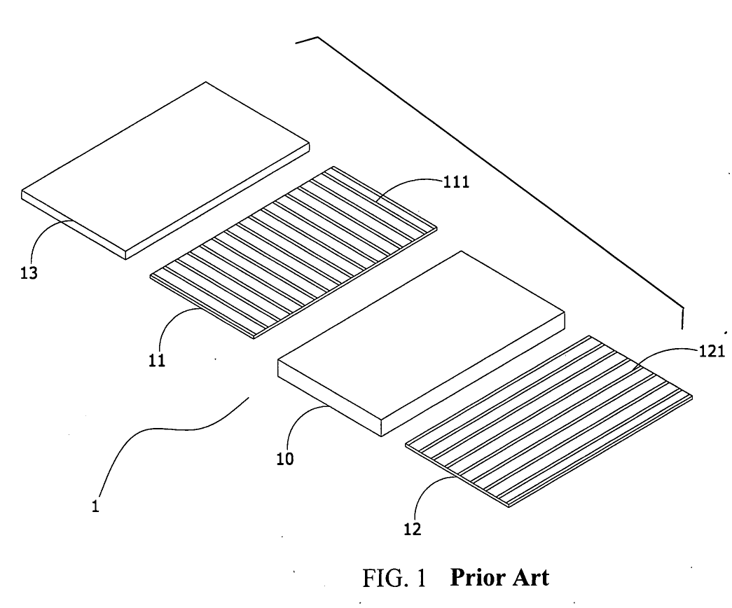

FIG. 2 is a three-dimensional exploded view of a preferred embodiment of the present invention;

FIG. 3 is a first partial schematic view of the preferred embodiment of the present invention;

FIG. 4 is a second part schematic view of the preferred embodiment of the present invention; and

FIG. 5 is a third schematic view of the preferred embodiment of the present invention.

### DETAILED DESCRIPTION OF THE INVENTION

In order to make the present invention more comprehensible, the present invention is described in the following with reference to the accompanying drawings.

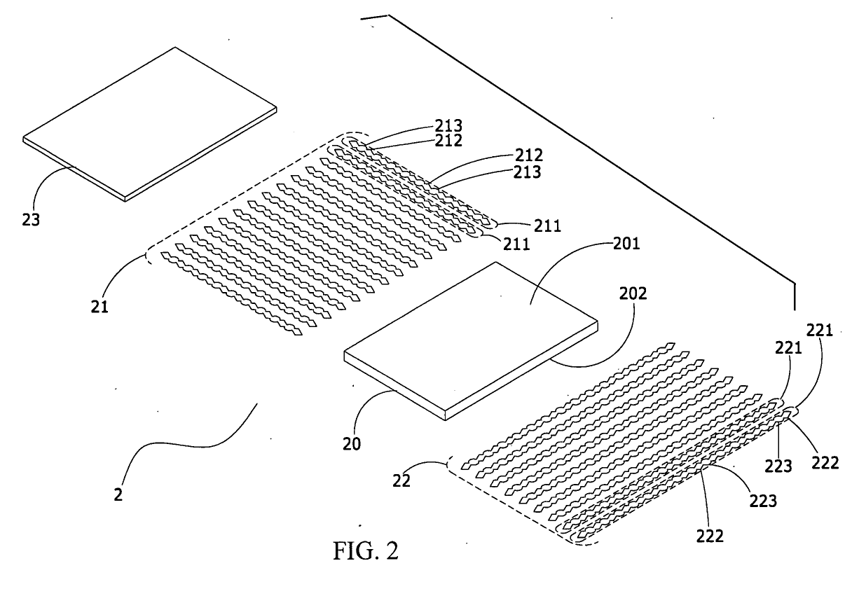

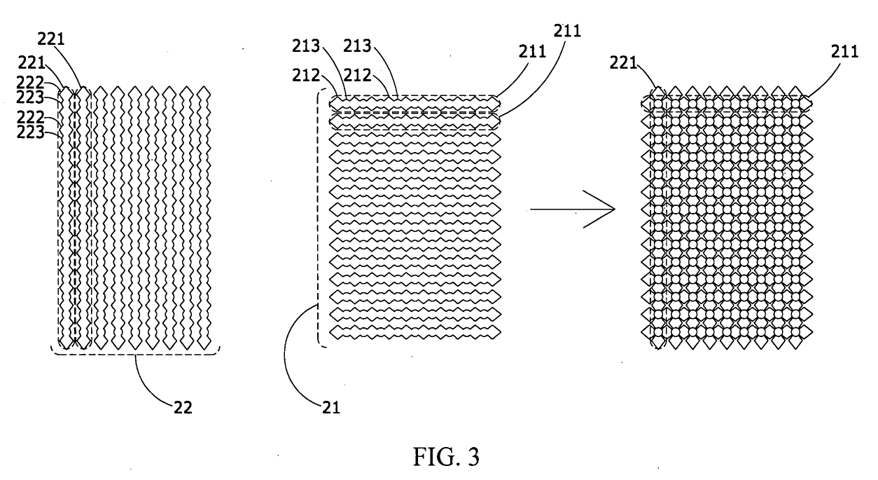

FIGS. 2 and 3 are a three-dimensional exploded view and a first partial schematic view of a preferred embodiment of the present invention respectively. As shown in FIGS. 2 and 3, the structural improvement to a touch panel of the present invention includes a touch panel 1, which has a substrate 20, a first induction layer 21, a second induction layer 22, and a protective layer 23.

The substrate 20 is made of a material of one of glass, poly carbonate (PC), ARTON, polyether sulfone (PES), ZEONOR, tri acetyl cellulose (TAC), polyethylene terephthalate (PET), or polymethyl methacrylate (PMMA). The substrate 20 has a first surface 201 and a second surface 202. When the first surface 201 is a top surface, the second surface 202 is a bottom surface. On the contrary, when the first surface 201 is a bottom surface, the second surface 202 is a top surface.

The first induction layer 21 is made of one of indium tin oxide (ITO), antimony tin oxide (ATO), aluminum zinc oxide (AZO), or a material selected from a group consisting of metal oxides of titanium (Ti), zinc (Zn), zirconium (Zr), antimony (Sb), indium (In), tin (Sn), aluminum (Al), and silicon (Si). The first induction layer 21 has a plurality of first induction lines 211. Each of the first induction lines 211 has a plurality of first induction blocks 212 having a same area, and the first induction blocks 212 are connected by first connection sections 213. The first connection sections 213 have a same area. In this embodiment, the round first connection sections 213 having the same area are taken as an example for illustration, while other shapes, such as one of a W shape, a V shape, a U shape, an M shape, an N shape, a Z shape, a corrugated shape, a consecutive curved shape, or a non-linear consecutive zigzag shape may also be adopted. Similarly, in this embodiment, the first induction blocks 212 in a rhombus shape is taken an example for illustration, while other shapes, such as one of a round shape, a parallelogram shape, a rhombus shape, a square shape, or a polygon shape may also be adopted.

The second induction layer 22 is made of one of indium tin oxide (ITO), antimony tin oxide (ATO), aluminum zinc oxide (AZO), or a material selected from a group consisting of metal oxides of titanium (Ti), zinc (Zn), zirconium (Zr), antimony (Sb), indium (In), tin (Sn), aluminum (Al), and silicon (Si). The second induction layer 22 has a plurality of second induction lines 221. Each of the second induction lines 221 has a plurality of second induction blocks 222 having a same area, and the second induction blocks 222 are connected by second connection sections 223. The second connection sections 223 have a same area. In this embodiment, the round second connection sections 223 having the same area are taken as an example for illustration, while other shapes, such as one of a W shape, a V shape, a U shape, an M shape, an N shape, a Z shape, a corrugated shape, a consecutive curved shape, or a non-linear consecutive zigzag shape may also be adopted. Similarly, in this embodiment, the second induction blocks 222 in a rhombus shape is taken an example for illustration, while other shapes, such as one of a parallelogram shape, a rhombus shape, a square shape, or a polygon shape may also be adopted.

The protective layer 23 is made of cyclo-olefin Copolymers (COC), silicon dioxide (SiO2), silicon nitride (SiNx) or plastic.

When the touch panel 1 is combined, the first induction layer 21 is disposed on a first surface 201of the substrate 20, and the second induction layer 22 is disposed on a second surface 202 of the substrate 20. The first induction lines 211 of the first induction layer 21 and the second induction lines 221 of the second induction layer 22 are electrically connected to an external control circuit (not shown). The protective layer 23 for protecting the first induction layer 21 is disposed on the surface of the first induction layer 21, so as to prevent the deformation or damage caused by the touch of a finger or external conductor when the touch panel 1 is touched. Also, because the protective layer 23 is very thin, the operation of touch panel 1 will not be influenced.

After the touch panel 1 is combined, the first induction lines 211 and the second induction lines 221 are located on the first surface 201 and the second surface 202 of the substrate 20 respectively, and are arranged alternately, such that the first induction blocks 212 and the second induction blocks 222 are arranged in a matrix or an array. Meanwhile, the first induction lines 211 and the second induction lines 221 take the first connection sections 213 and the second connection sections 223 as the overlapped area. It should be noted that not only the area of the first induction blocks 212 must be the same and the area of the second induction blocks 222 must be the same, but also the areas of both the first induction blocks 212 and the second induction blocks 222 must be the same. Similarly, not only the area of the first connection sections 213 must be the same and the area of the second connection sections 223 must be the same, but also the areas of both the first connection sections 213 and the second connection sections 223 must be the same.

Thereby, the first induction lines 211, the first induction blocks 212, and the first connection sections 213 of the first induction layer 21, and the second induction lines 221, the second induction blocks 222, and the second connection sections 223 of the second induction layer 22 are respectively distributed on the whole first surface 201 and the whole second surface 202 of the substrate 20 evenly. Meanwhile, after the first induction layer 21 and the second induction layer 22 are stacked on the substrate 20, the blank area generated by overlapping the first induction layer 21 and the second induction layer 22 can be reduced, and the touch area of the substrate 20 can be increased. And, if the touch point is at the first connection section 213 and the second connection section 223, the capacity effect generated by the first connection section 213 and the second connection section 223 is the same because they have the same area, so as to prevent the error determination and inaccuracy when the external control circuit of the touch panel 2 analyzes and controls the touch point.

In this embodiment, the first induction blocks 212 of the first induction layer 21 perform X-direction touch point induction, while the second induction blocks 222 of the second induction layer 22 perform Y-direction touch point induction. Whereas, the first induction blocks 212 may also perform the Y-direction touch point induction, and the second induction blocks 222 may also perform the X-direction touch point induction. That is, the X-axis direction and the Y-axis direction represented by the first induction layer 21 and the second induction layer 22 do not influence the structural features of the present invention.

Furthermore, besides the combination sequence described in this embodiment, the first induction layer 21 may be disposed on the second surface 202 of the substrate 20, the second induction layer 22 may be disposed on the first surface 201 of the substrate 20, and the protective layer 23 may be disposed on the surface of the second induction layer 22.

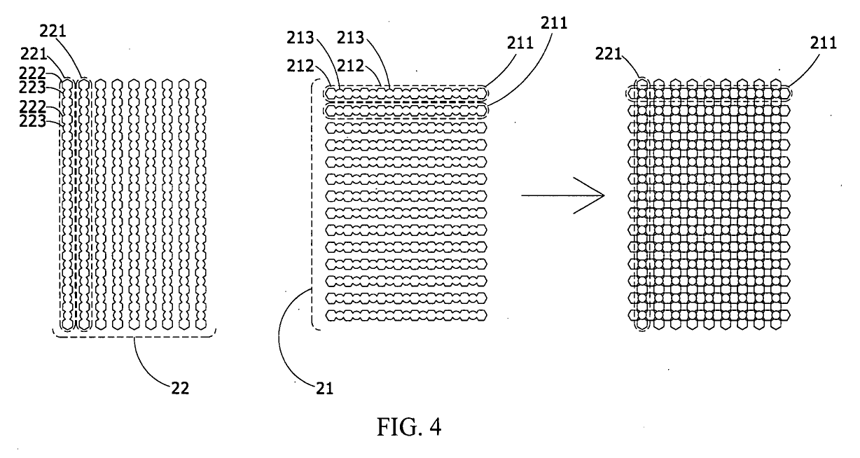

FIGS. 2 and 4 are a three-dimensional exploded view and a second partial schematic view of the preferred embodiment of the present invention. As shown in FIGS. 2 and 4, in this embodiment, the first induction block 212 and the second induction block 222 still have the same area, but may also be in one of a parallelogram shape, a square shape, or a polygon shape besides the rhombus shape in FIG. 2.

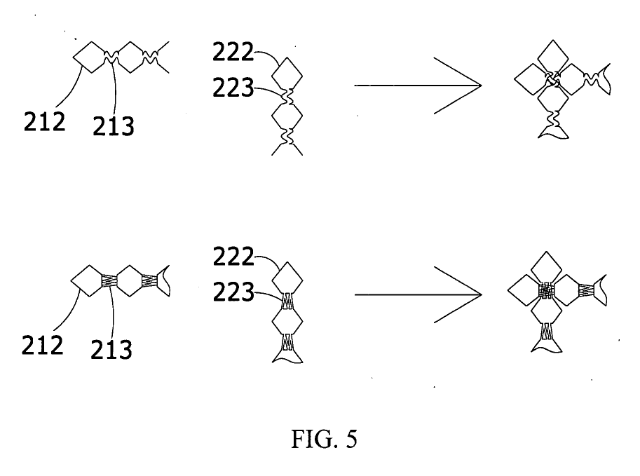

FIGS. 2 and 5 are a three-dimensional exploded view and a third partial schematic view of the preferred embodiment of the present invention. As shown in FIGS. 2 and 5, in this embodiment, the first connection section 213 and the second connection section 223 still have the same area, but may also be in one of a W shape, a V shape, a U shape, an M shape, an N shape, a Z shape, a corrugated shape, a consecutive curved shape, or a non-linear consecutive zigzag shape besides the round shape in FIG. 2.

However, the above description is only preferred embodiments of this invention, and is not used to limit the scope of the present invention. Equivalent variations and modifications made by those skilled in the art without departing from the spirit or scope of the present invention should be covered within the claims of the present invention.

To sum up, the structural improvement to a touch panel of the present invention meets the inventiveness requirements for a patent, and has the industrial applicability. Thus, according to the Patent Law, the applicant has filed an invention patent application to the Intellectual Property Office.

What is claimed is:

1. A structural improvement to a touch panel, the touch panel comprising a substrate, a first induction layer disposed on a first surface of the substrate, and a second induction layer disposed on a second surface of the substrate, wherein
the first induction layer has a plurality of first induction lines, and each of the first induction lines has a plurality of first induction blocks connected by first connection sections; the second induction layer has a plurality of second induction lines, and each of the second induction lines has a plurality of second induction blocks connected by second connection sections; the first induction lines and the second induction lines are arranged alternately, and the first connection sections and the second connection sections are in an overlapped area.

2. The structural improvement to a touch panel according to claim 1, wherein the first induction blocks and the second induction blocks have a same area, and are in one of a round shape, a parallelogram shape, a rhombus shape, a square shape, and a polygon shape.

3. The structural improvement to a touch panel according to claim 1, wherein the first connection sections and the second connection sections have a same area, and are in a round shape.

4. The structural improvement to a touch panel according to claim 1, wherein the first connection sections and the second connection sections have a same area, and are in one of a W shape, a V shape, a U shape, an M shape, an N shape, a Z shape, a corrugated shape, a consecutive curved shape, or a non-linear consecutive zigzag shape.

5. The structural improvement to a touch panel according to claim 1, wherein the first induction lines and the second induction lines are arranged alternately, and the first induction blocks and the second induction blocks are arranged in a matrix or an array.

6. The structural improvement to a touch panel according to claim 1, wherein the first induction layer and the second induction layer are made of one of indium tin oxide (ITO), antimony tin oxide (ATO), aluminum zinc oxide (AZO), or a material selected from a group consisting of metal oxides of titanium (Ti), zinc (Zn), zirconium (Zr), antimony (Sb), indium (In), tin (Sn), aluminum (Al), and silicon (Si).

7. The structural improvement to a touch panel according to claim 1, wherein a protective layer is disposed on a surface of the first induction layer.

8. The structural improvement to a touch panel according to claim 7, wherein the protective layer is made of one of cyclo-olefin copolymers (COC), silicon dioxide (SiO2), silicon nitride (SiNx), or plastic.

9. The structural improvement to a touch panel according to claim 1, wherein the substrate is made of one of glass, poly carbonate (PC), ARTON, polyether sulfone (PES), ZEONOR, tri acetyl cellulose (TAC), polyethylene terephthalate (PET), or polymethyl methacrylate (PMMA).

10. A structural improvement to a touch panel, the touch panel comprising a substrate, a first induction layer disposed on a first surface of the substrate, and a second induction layer disposed on a second surface of the substrate, wherein
the first induction layer has a plurality of first induction lines, each of the first induction lines has a plurality of first induction blocks having a same area, and the first induction blocks are connected by round first connection sections having a same area; while the second induction layer has a plurality of second induction lines, each of the second induction lines has a plurality of second induction blocks having a same area, and the second induction blocks are connected by round second connection sections having a same area; the first induction lines and the second induction lines are arranged alternately, and the first connection sections and the second connection sections are in an overlapped area.

11. The structural improvement to a touch panel according to claim 10, wherein the first induction blocks and the second induction blocks have the same area, and are in one of a round shape, a parallelogram shape, a rhombus shape, a square shape, and a polygon shape.

12. The structural improvement to a touch panel according to claim 10, wherein the first induction lines and the second induction lines are arranged alternately, and the first induction blocks and the second induction blocks are arranged in a matrix or an array.

13. The structural improvement to a touch panel according to claim 10, wherein the first induction layer and the second induction layer are made of one of indium tin oxide (ITO), antimony tin oxide (ATO), aluminum zinc oxide (AZO), or a material selected from a group consisting of metal oxides of titanium (Ti), zinc (Zn), zirconium (Zr), antimony (Sb), indium (In), tin (Sn), aluminum (Al), and silicon (Si).

14. The structural improvement to a touch panel according to claim 10, wherein a protective layer is disposed on a surface of the first induction layer.

15. The structural improvement to a touch panel according to claim 14, wherein the protective layer is made of one of cyclo-olefin copolymers (COC), silicon dioxide (SiO2), silicon nitride (SiNx), or plastic.

16. The structural improvement to a touch panel according to claim 10, wherein the substrate is made of one of glass, poly carbonate (PC), ARTON, polyether sulfone (PES), ZEONOR, tri acetyl cellulose (TAC), polyethylene terephthalate (PET), or polymethyl methacrylate (PMMA).

17. A structural improvement to a touch panel, the touch panel comprising a substrate, a first induction layer disposed on a first surface of the substrate, and a second induction layer disposed on a second surface of the substrate, wherein
the first induction layer has a plurality of first induction lines, each of the first induction lines has a plurality of first induction blocks having a same area, and the first induction blocks are connected by curved first connection sections having a same area; the second induction layer has a plurality of second induction lines, each of the second induction lines has a plurality of second induction blocks having a same area, and the second induction blocks are connected by curved second connection sections having a same area; the first induction lines and the second induction lines are arranged alternately, and the first connection sections and the second connection sections are in an overlapped area.

18. The structural improvement to a touch panel according to claim 17, wherein the first induction blocks and the second induction blocks have the same area, and are in one of a round shape, a parallelogram shape, a rhombus shape, a square shape, and a polygon shape.

19. The structural improvement to a touch panel according to claim 17, wherein the first connection sections and the second connection sections are in one of a W shape, a V shape, a U shape, an M shape, an N shape, a Z shape, a corrugated shape, a consecutive curved shape, or a non-linear consecutive zigzag shape.

20. The structural improvement to a touch panel according to claim 17, wherein the first induction lines and the second induction lines are arranged alternately, and the first induction blocks and the second induction blocks are arranged in a matrix or an array.

21. The structural improvement to a touch panel according to claim 17, wherein the first induction layer and the second induction layer are made of one of indium tin oxide (ITO), antimony tin oxide (ATO), aluminum zinc oxide (AZO), or a material selected from a group consisting of metal oxides of titanium (Ti), zinc (Zn), zirconium (Zr), antimony (Sb), indium (In), tin (Sn), aluminum (Al), and silicon (Si).

22. The structural improvement to a touch panel according to claim 17, wherein a protective layer is disposed on a surface of the first induction layer.

23. The structural improvement to a touch panel according to claim 22, wherein the protective layer is made of one of cyclo-olefin copolymers (COC), silicon dioxide (SiO2), silicon nitride (SiNx), or plastic.

24. The structural improvement to a touch panel according to claim 1, wherein the substrate is made of one of glass, poly carbonate (PC), ARTON, polyether sulfone (PES), ZEONOR, tri acetyl cellulose (TAC), polyethylene terephthalate (PET), or polymethyl methacrylate (PMMA).
